(19) United States
(12) Patent Application Publication
(10) Pub. No.: US 2018/0150276 A1
(43) Pub. Date: May 31, 2018

(54) SYSTEM AND METHOD FOR ENABLING COMMUNICATION OF AMBIENT SOUND AS AN AUDIO STREAM

(71) Applicant: SPOTIFY AB, Stockholm (SE)

(72) Inventors: PETR VACEK, Stockholm (SE); IGOR TRNCIC, Stockholm (SE)

(21) Appl. No.: 15/363,811

(22) Filed: Nov. 29, 2016

(51) Int. Cl. G06F 3/16; H04L 29/06; H04N 21/472

(52) U.S. Cl. CPC G06F 3/165; H04N 21/47217; H04L 65/60

(57) ABSTRACT

The present disclosure relates to a method performed by a communication device communicatively connected to a headphone. The method comprises outputting a first audio stream to the headphone for playback to a user of the communication device. The method also comprises, via an interface and/or of the communication device to its surroundings, obtaining an indication that the playback of the first audio stream should be altered. The method also comprises, in response to the obtained indication: altering the output of the first audio stream; by means of a microphone of the communication device, recording a second audio stream; and outputting the second audio stream to the headphone for playback to the user.

### TECHNICAL FIELD

The present disclosure relates to a communication device connected to a headphone and to enabling communication of ambient sound, including outputting an audio stream to the headphone for playback to a user of the communication device.

### BACKGROUND

When using headphones for e.g. listening to music, it is often desirable to shut out ambient sounds in order to improve the listening experience. There are also actively noise cancelling headphones on the marked for further reduction of sound pollution when using the headphones. This implies that it may be difficult for a person using the headphones to hear another person trying to talk to him/her, unless the headphones are turned off or removed.

### SUMMARY

It is an objective of the present invention to improve verbal communication with a person wearing headphones, without the need to remove the headphones from the ears of said person.

According to an aspect of the present invention, there is provided a method performed by a communication device communicatively connected to a headphone (or headphones). The method comprises outputting a first audio stream to the headphone for playback to a user of the communication device. The method also comprises, via an interface of the communication device to its surroundings, obtaining an indication that the playback of the first audio stream should be altered. The method also comprises, in response to the obtained indication, altering the output of the first audio stream; by means of a microphone of the communication device, recording a second audio stream; and outputting the second audio stream to the headphone for playback to the user.

According to another aspect of the present invention, there is provided a computer program product comprising computer-executable components for causing a communication device to perform an embodiment of the method of the present disclosure when the computer-executable components are run on processing circuitry comprised in the communication device.

According to another aspect of the present invention, there is provided a communication device comprising processing circuitry, and storage storing instructions executable by said processing circuitry whereby said communication device is operative to output a first audio stream to a headphone for playback to a user of the communication device. The communication device is also operative to, via an interface of the communication device to its surroundings, obtain an indication that the playback of the first audio stream should be altered. The communication device is also operative to, in response to the obtained indication: alter the output of the first audio stream; by means of a microphone of the communication device, record a second audio stream; and output the second audio stream to the headphone for playback to the user.

By altering the output of the first audio stream, e.g. discontinuing it, muting it, fading it out or reducing the volume of it, and using the microphone of the communication device (also called only device herein) for capturing and playing back, effectively amplifying, ambient sound (typically voice), the user of the communication device wearing the headphone(s) may better hear the ambient sound (via the microphone) without the need to remove the headphone(s). This may be called a voice mode of the device.

It is to be noted that any feature of any of the aspects may be applied to any other aspect, wherever appropriate. Likewise, any advantage of any of the aspects may apply to any of the other aspects. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second” etc. for different features/components of the present disclosure are only intended to distinguish the features/components from other similar features/components and not to impart any order or hierarchy to the features/components.

### BRIEF DESCRIPTION OF THE DRAWINGS

Embodiments will be described, by way of example, with reference to the accompanying drawings, in which:

FIG. 1a-d schematically illustrates some embodiments of the present invention.

FIG. 2a-d schematically illustrates some other embodiments of the present invention.

FIG. 3 is a schematic block diagram of an embodiment of a communication device of the present invention.

FIG. 4 is a schematic illustration of an embodiment of a computer program product of the present invention.

FIG. 5 is a schematic flow chart of embodiments of the method of the present invention.

### DETAILED DESCRIPTION

Embodiments will now be described more fully hereinafter with reference to the accompanying drawings, in which certain embodiments are shown. However, other embodiments in many different forms are possible within the scope of the present disclosure. Rather, the following embodiments are provided by way of example so that this disclosure will be thorough and complete, and will fully convey the scope of the disclosure to those skilled in the art. Like numbers refer to like elements throughout the description.

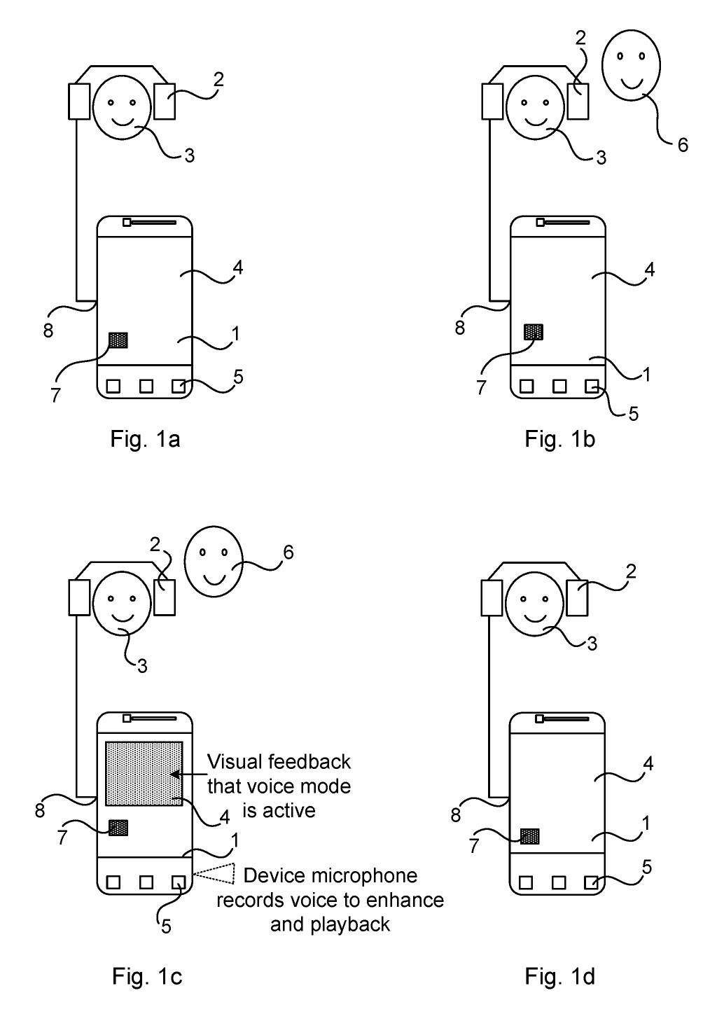

FIGS. 1a-d and 2a-d illustrate steps of some embodiments of the present invention. A communication device 1 is communicatively connected to a headphone or headphones 2 worn by a person 3 who is herein called a user of the communication device. The headphone(s) comprises speakers for playing back audio, e.g. music, to the user 3, and is e.g. arranged in, on or over an ear (or both ears) of the user.

The communication device 1 may e.g. be configured for wired power supply or comprise a battery. The communication device may e.g. be a radio device such as any device or user equipment (UE), mobile or stationary, enabled to communicate over a radio channel in a communication network, for instance but not limited to e.g. mobile phone, smartphone, media players, or any type of consumer electronic, for instance but not limited to television, radio, tablet computer, laptop, or personal computer (PC). The device 1 is communicatively connected, wired or wirelessly, to the headphone 2 via a headphone interface 8 for outputting an audio stream to the headphone 2 which may then be played back to the user by means of its speakers. In case of a wired headphone connection, the headphone interface may e.g. comprise a receiver for a headphone connector such as a 3.5 mm connector, a Lightning connector or a USB connector (e.g. a micro USB or USB-C). In case of a wireless headphone interface, the headphone interface may comprise a radio interface e.g. for Bluetooth, Local Area Network (LAN) or W-Fi, or Near-Field Communication (NFC). The device may also comprise a communication interface for a data connection e.g. to the Internet, which may be wired or wireless e.g. in accordance with a LAN or Third Generation Partnership Project (3GPP) communication standard. The device 1 also comprises a microphone interface 5, e.g. a microphone, and a User Interface (UI) 4 e.g. a Graphical UI (GUI) optionally comprising a touchscreen. Additionally or alternatively, the UI 4 may comprise mechanical buttons or keys.

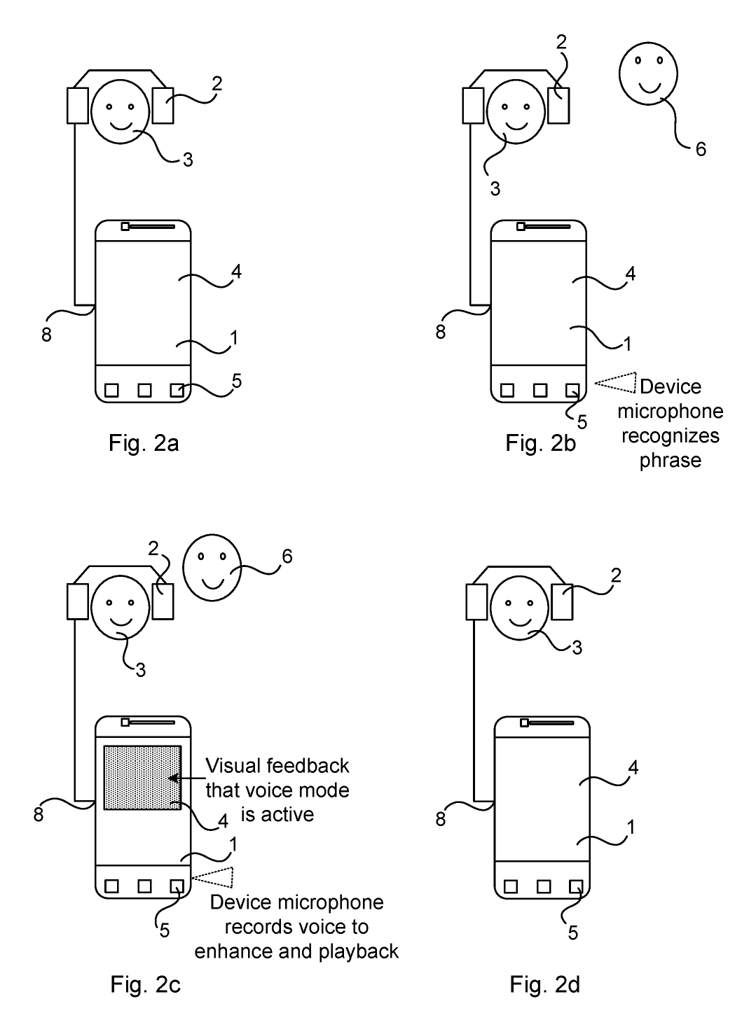

In the situation shown in FIGS. 1a and 2a, respectively, a user 3 listens to an audio stream (herein called a first audio stream) e.g. music or an audio book, by means of the headphone 2 connected to the device 1. The first audio stream may be of a media file, or playlist of a plurality of media files, which is e.g. stored in a storage in the device 1 or streamed by the device from an external media server (being buffered in the device) and outputted to the headphone. This may be regarded as a starting situation for embodiments of the method of the present invention. The user may e.g. be working or travelling and uses the headphone and the first audio stream avoid disturbing ambient sounds.

In the example situation shown in FIG. 1b, the user 3 decides that he/she wants to, e.g. temporarily, hear ambient sound e.g. of what another person 6 is saying. The user 3 then uses the UI 4 to input a command to the device 1 to put the device in what is herein called voice mode, whereby the device receives an indication that the playback of the first audio stream should be altered in accordance with the voice mode. If the UI comprises a touchscreen, the user may e.g. input the command by making a touch gesture or by pressing a graphical element 7 of the GUI, which graphical element is associated with the voice mode and thus provides the indication to the device. The graphical element 7 may e.g. be presented by a software (SW) application (app) or widget running in the device, e.g. integrated in a media player in the device. The user may thus easily switch to voice mode by interaction via the UI 4.

Additionally or alternatively, in the example situation shown in FIG. 2b, the switching to voice mode may be initiated automatically, without the need for the user 3 to interact with the device 1 via the UI 4. In this situation, the device 1 detects a predefined sound by means of the microphone 5. The device has been preprogrammed to associate this sound with an indication that the device should be put in voice mode. The microphone may thus be active and, when the sound is detected, the device 1 is automatically put in voice mode. The sound may e.g. be a human voice. The human voice may have a volume which is above a predetermined threshold, e.g. a static threshold or a threshold which is relative to background noise in order to qualify as an indication for putting the device in voice mode. Additionally or alternatively, the human voice may have to speak a predetermined phrase, e.g. an activation word or phrase such as a name of the user 3. By this, an other person 6, or e.g. a speaker system in a train or plane, may automatically activate the voice mode without the user 3 having to see that the other person 6 is trying to make contact or without the other person having to speak loudly to be heard over the playback of the first audio stream. This may make it easier and less awkward to make contact with the user 3. For instance, if the user 3 is working while listening via headphones 2 it may be socially awkward to approach him/her which may require either entering the field of vision of the user 3, gesturing or tapping him/her or talking really loudly in order to get noticed and start a conversation.

FIGS. 1c and 2c, respectively, shows the situation after the device 1 has been put in voice mode, e.g. following any of the situations of FIG. 1b or 2b. The output of the first audio stream to the headphone 2 has been altered, e.g. such that the playback by means of the speakers in the headphone has been interrupted (stopped), muted, faded out, or reduced in volume, in order to allow the user 3 to hear ambient sound. The ambient sound is obtained/recorded by means of the microphone 5 and outputted to the headphone 2 as a second audio stream for playback to the user via the speakers. The ambient sound of the second audio stream typically comprises a human voice, and in some embodiments an audio filter (typically a digital audio filter) may be used to enhance the human voice and/or reduce noise before outputting the second audio stream to the headphone. In some embodiments, visual feedback to the user that the voice mode is active may be presented by means of the GUI 4. Thus, the user may hear another person (or a speaker system) via the microphone 5 in the device 1 and the speakers in the headphone 2, without the need for removing the headphone(s).

The device 1 may be kept in voice mode until the device, e.g. via an interface (e.g. UI 4 and/or microphone 5), obtains an indication that the playback of the first audio stream should be restored to as before the obtaining of the indication that the playback of the first audio stream should be altered. In response to the obtained indication that the playback of the first audio stream should be restored, the device 1 may discontinue the recording and outputting of the second audio stream, and alter the output of the first audio stream such that the playback of the first audio stream is restored to as it was before the obtaining of the indication that the playback of the first audio stream should be altered (e.g. as discussed in respect of FIGS. 1a and 2a).

The situations shown in FIGS. 1d and 2d, respectively, illustrates embodiments of the present invention after the playback of the first audio stream should be restored, similar to FIGS. 1a and 2a. Depending on how the output of the first audio stream was altered, the first audio stream output may be similarly restored, e.g. resumed (started), unmuted, faded in, or increased in volume.

In FIG. 1d, where the indication that the playback of the first audio stream should be altered was obtained via the UI 4, the indication that the first audio stream should be restored may similarly be obtained via the UI 4, e.g. by making a touch gesture or by the user pressing the same, or a different, graphical element 7 of the GUI, or by releasing pressure on said graphical element 7 if the voice mode is only active while the user is continuously pressing the graphical element.

In FIG. 2d, where the indication that the playback of the first audio stream should be altered was obtained via the microphone 5, the indication that the first audio stream should be restored may similarly be obtained via the microphone 5, e.g. by detecting that the human voice is no longer heard, or is below a predetermined volume threshold, during a predetermined time period.

Additionally or alternatively, the indication that the first audio stream should be restored may be obtained by the expiry of a timer which was activated when the device 1 was put in the voice mode.

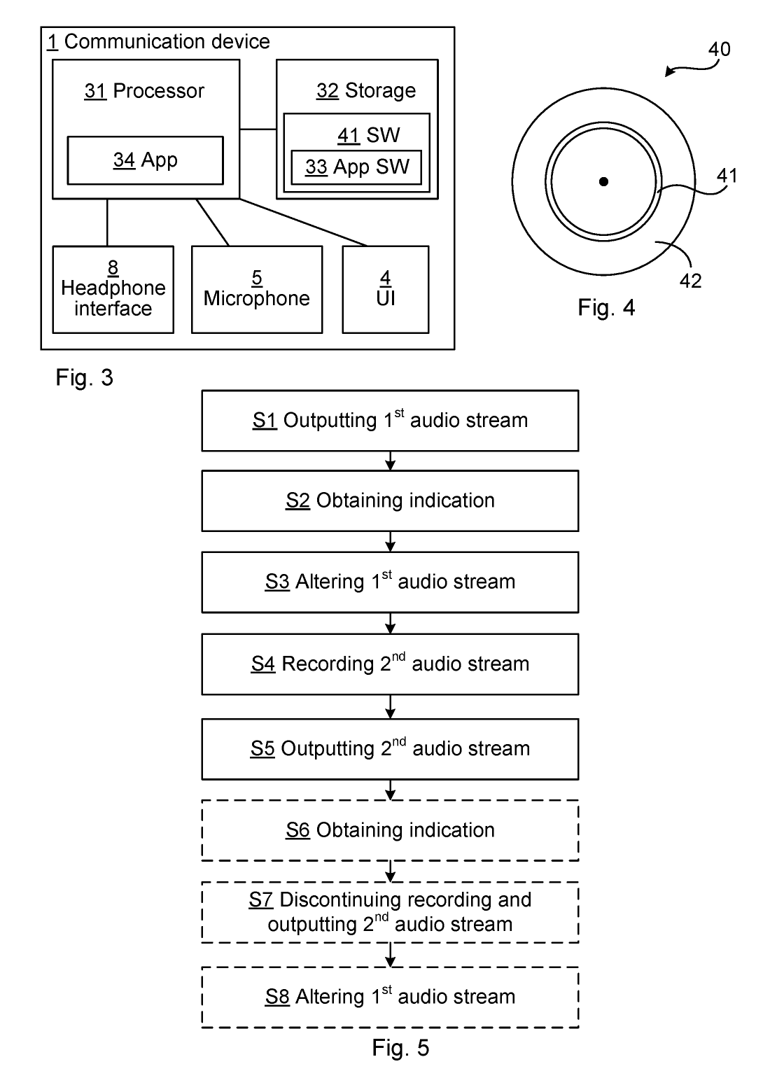

FIG. 3 schematically illustrates an embodiment of a communication device 1 of the present disclosure. The device 1 comprises processing circuitry 31 e.g. a central processing unit (CPU). The processing circuitry 31 may comprise one or a plurality of processing units in the form of microprocessor(s). However, other suitable devices with computing capabilities could be comprised in the processing circuitry 31, e.g. an application specific integrated circuit (ASIC), a field programmable gate array (FPGA) or a complex programmable logic device (CPLD). The processing circuitry 31 is configured to run one or several computer program(s) or software (SW) 41 (see also FIG. 4) stored in a storage 32 of one or several storage unit(s) e.g. a memory. The storage unit is regarded as a computer readable means 42 (see FIG. 4) as discussed herein and may e.g. be in the form of a Random Access Memory (RAM), a Flash memory or other solid state memory, or a hard disk, or be a combination thereof. The processing circuitry 31 may also be configured to store data in the storage 32, as needed. The SW 41 may comprise SW for making the device perform embodiments of the method of the present disclosure. The SW 41 may e.g. comprise app SW 33 which, when run on the processing circuitry 31 forms the app 34 by means of which the device 1 may perform at least a part of embodiments of the method. The device 1 also comprises the audio output/headphone interface 8, the microphone 5 and the UI 4 as previously discussed.

FIG. 4 illustrates an embodiment of a computer program product 40. The computer program product 40 comprises a computer readable (e.g. non-volatile and/or non-transitory) medium 42 comprising software/computer program 41 in the form of computer-executable components. The computer program 41 may be configured to cause a device 1, e.g. as discussed herein, to perform an embodiment of the method of the present disclosure. The computer program may be run on the processing circuitry 31 of the device 1 for causing it to perform the method. The computer program product 40 may e.g. be comprised in a storage unit or memory 32 comprised in the device 1 and associated with the processing circuitry 31. Alternatively, the computer program product 40 may be, or be part of, a separate, e.g. mobile, storage means/medium, such as a computer readable disc, e.g. CD or DVD or hard disc/drive, or a solid state storage medium, e.g. a RAM or Flash memory. Further examples of the storage medium can include, but are not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Embodiments of the present disclosure may be conveniently implemented using one or more conventional general purpose or specialized digital computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

FIG. 5 is a schematic flow chart of some embodiments of the method of the present invention. The method is performed by a communication device 1 communicatively connected to a headphone 2. The method comprises outputting S1 a first audio stream to the headphone for playback to a user 3 of the communication device. The method also comprises, via an interface (e.g. UI 4 and/or microphone 5) to the surroundings of the device 1, obtaining S2 an indication that the playback of the first audio stream should be altered. The method also comprises, in response to the obtained S2 indication: altering S3 the output of the first audio stream; by means of the microphone 5 of the communication device, recording S4 a second audio stream; and outputting S5 the second audio stream to the headphone for playback to the user.

In some embodiments, the method may further comprise, via the interface 4 and/or 5, obtaining S6 an indication that the playback of the first audio stream should be restored to as before the obtaining S2 of the indication that the playback of the first audio stream should be altered. The method may also comprise, in response to the obtained S6 indication that the playback of the first audio stream should be restored: discontinuing S7 the recording S4 and outputting S5 of the second audio stream; and altering S8 the output of the first audio stream such that the playback of the first audio stream is restored.

In some embodiments, the first audio stream is of a media file stored in the communication device 1 or streamed from a media server.

In some embodiments, the interface 4 comprises a touchscreen of a GUI, and the indication is obtained S2 by detecting an input via the touchscreen corresponding to the user 3 pressing a graphical element of the GUI associated with the indication that the playback of the first audio stream should be altered.

In some embodiments, the interface comprises the microphone 5, and the indication is obtained S2 by via the microphone detecting sound which the communication device 1 has been preprogrammed to associate with the indication that the playback of the first audio stream should be altered. In some embodiments, the sound comprises a human voice. In some embodiments, the detected human voice sound has a volume above a predetermined threshold. In some embodiments, the detected human voice sound corresponds to a predetermined phrase.

In some embodiments, the recording S4 of the second audio stream comprises using an audio filter to reduce noise in the second audio stream.

In some embodiments, the method is performed at least partly by means of a software application 34 running on the communication device 1.

In some embodiments, the communication device is a mobile phone, e.g. a smartphone.

In some embodiments, the interface of the device 1 comprises a touchscreen of a UI 4 e.g. GUI, or the interface comprises a microphone 5.

The present disclosure has mainly been described above with reference to a few embodiments. However, as is readily appreciated by a person skilled in the art, other embodiments than the ones disclosed above are equally possible within the scope of the present disclosure, as defined by the appended claims.

1. A method performed by a communication device having a microphone and a headphone interface for outputting audio streams to a headphone communicatively coupled to the communication device, the method comprising:
outputting, by the communication device, via the headphone interface of the communication device, a first audio stream received at the communication device from a media server, to the headphone, for playback at the headphone;
receiving, via an interface of the communication device to its surroundings, an indication that the playback of the first audio stream received at the communication device from the media server should be altered;
in response to the received indication that the playback of the first audio stream received at the communication device from the media server should be altered, placing the communication device in a voice mode, including:
altering, by the communication device, the output of the first audio stream being received at the communication device from the media server and provided to the headphone interface, by at least one of discontinuing, muting, fading, or reducing a volume of, the first audio stream being provided to the headphone interface,
recording, by the communication device, via the microphone of the communication device, ambient sound, as a second audio stream, and
outputting, by the communication device, via the headphone interface of the communication device, the second audio stream including the ambient sound recorded by the communication device, to the headphone, for playback at the headphone.

2. (canceled)

3. The method of claim 1, wherein the interface of the communication device to its surroundings comprises a touchscreen of a GUI, and wherein the indication that the playback of the first audio stream should be altered, is received by detecting an input via the touchscreen corresponding to pressing of a graphical element of the GUI associated with the indication.

4. (canceled)

5. The method of claim 1, wherein the interface of the communication device to its surroundings comprises the microphone, and wherein the indication that the playback of the first audio stream should be altered, is received by the microphone detecting a sound which the communication device has been preprogrammed to associate with the indication.

6. (canceled)

7. The method of claim 5, wherein the sound comprises a human voice.

8. The method of claim 7, wherein the sound has a volume above a predetermined threshold.

9. The method of claim 7, wherein the sound corresponds to a predetermined phrase.

10. The method of claim 8, wherein the sound corresponds to a predetermined phrase.

11. The method of claim 1, wherein the applying an audio filter to the ambient sound, before outputting filtered ambient sound as the second audio stream, comprises using the audio filter to reduce noise in the second audio stream.

12. The method of claim 1, further comprising:
receiving, via the interface of the communication device to its surroundings, an indication that the playback of the first audio stream should be restored; and
in response to the received indication that the playback of the first audio stream should be restored:
discontinuing the recording and outputting of the second audio stream, and
altering the output of the first audio stream such that the playback of the first audio stream is restored.

13. The method of claim 1, wherein the method is performed by a software application running on the communication device.

14. A non-transitory computer program product comprising computer-executable components for causing a communication device having a microphone and a headphone interface for outputting audio streams to a headphone communicatively coupled to the communication device, to perform a method, when the computer-executable components are run on processing circuitry comprised in the communication device, of:
outputting, by the communication device, via the headphone interface of the communication device, a first audio stream received at the communication device from a media server, to the headphone, for playback at the headphone;
receiving, via an interface of the communication device to its surroundings, an indication that the playback of the first audio stream received at the communication device from the media server should be altered;
in response to the received indication that the playback of the first audio stream received at the communication device from the media server should be altered, placing the communication device in a voice mode, including:
altering, by the communication device, the output of the first audio stream being received at the communication device from the media server and provided to the headphone interface, by at least one of discontinuing, muting, fading, or reducing a volume of, the first audio stream being provided to the headphone interface,
recording, by the communication device, via the microphone of the communication device, ambient sound, as a second audio stream, and
outputting, by the communication device, via the headphone interface of the communication device, the second audio stream including the ambient sound recorded by the communication device, to the headphone, for playback at the headphone.

15. A communication device comprising:
processing circuitry;
a microphone;
a headphone interface for outputting audio streams to a headphone communicatively coupled to the communication device; and
storage storing instructions executable by said processing circuitry, whereby said communication device is operative to:
output, via the headphone interface of the communication device, a first audio stream received at the communication device from a media server, to the headphone, for playback at the headphone;
receive, via an interface of the communication device to its surroundings, an indication that the playback of the first audio stream received at the communication device from the media server should be altered;
in response to the received indication that the playback of the first audio stream received at the communication device from the media server should be altered, place the communication device in a voice mode, including:
altering, by the communication device, the output of the first audio stream being received at the communication device from the media server and provided to the headphone interface, by at least one of discontinuing, muting, fading, or reducing a volume of, the first audio stream being provided to the headphone interface,
recording, by the communication device, via the microphone of the communication device, ambient sound, as a second audio stream, and
outputting, by the communication device, via the headphone interface of the communication device, the second audio stream including the ambient sound recorded by the communication device, to the headphone, for playback at the headphone.

16. The communication device of claim 15, wherein the communication device is a mobile phone.

17. The communication device of claim 15, wherein the interface of the communication device to its surroundings comprises a touchscreen of a GUI, and wherein the indication that the playback of the first audio stream should be altered, is received by detecting an input via the touchscreen corresponding to pressing of a graphical element of the GUI associated with the indication.

18. The communication device of claim 16, wherein the interface of the communication device to its surroundings comprises the microphone, and wherein the indication that the playback of the first audio stream should be altered, is received by the microphone detecting a sound which the communication device has been preprogrammed to associate with the indication.

19. The method of claim 12, wherein the indication that the playback of the first audio stream should be restored is received by at least one of:
detecting a user input at a user interface of the communication device, or
detecting, by the microphone of the communication device, that a particular sound is no longer heard, or is below a predetermined volume threshold.

20. The method of claim 12, wherein altering the output of the first audio stream such that the playback of the first audio stream is restored comprises at least one of resuming, unmuting, fading in, or increasing the volume of, the first audio stream.

21. The communication device of claim 18, wherein the sound comprises a human voice.

22. The communication device of claim 18, wherein the sound has a volume above a predetermined threshold.

23. The communication device of claim 18, wherein the sound corresponds to a predetermined phrase.
